(19) United States
(12) Patent Application Publication
(10) Pub. No.: US 2025/0331699 A1
(43) Pub. Date: Oct. 30, 2025

(54) DISHWASHER

(71) Applicant: SAMSUNG ELECTRONICS CO., LTD., Suwon-si (KR)

(72) Inventors: Hyeonho LEE, Suwon-si (KR); Gimun GWAK, Suwon-si (KR); Jungha PARK, Suwon-si (KR); Keonpyo KOO, Suwon-si (KR); Hyunjun CHUNG, Suwon-si (KR)

(73) Assignee: SAMSUNG ELECTRONICS CO., LTD., Suwon-si (KR)

(21) Appl. No.: 19/187,345

(22) Filed: Apr. 23, 2025

Related U.S. Application Data
(63) Continuation of application No. PCT/KR2025/004886, filed on Apr. 10, 2025.

(30) Foreign Application Priority Data
Apr. 30, 2024 (KR) 10-2024-0057754
Sep. 26, 2024 (KR) 10-2024-0131036

(51) Int. Cl. A47L 15/42; A47L 15/00; C02F 1/46; C02F 1/469

(52) U.S. Cl. CPC A47L 15/4206; A47L 15/0028; A47L 15/4217; C02F 1/4602; C02F 1/4691; A47L 15/4223; C02F 2307/12

(57) ABSTRACT

A dishwasher includes: a tub; a sprayer disposed in the tub and configured to spray water; a sump configured to receive the water; a capacitive deionization filter configured to filter the water supplied from a water source before the water is supplied to the sump; a case brake configured to allow the water passing through the capacitive deionization filter to flow to the sump and prevent the water from flowing back toward the capacitive deionization filter; a tank configured to store the water after the water is passed through the capacitive deionization filter; a first flow path connecting the capacitive deionization filter and the tank; a second flow path connecting the capacitive deionization filter and the case brake; a third flow path connecting the tank and the sump; and a fourth flow path connecting the case brake and the sump.

### CROSS-REFERENCE TO RELATED APPLICATIONS

This application is a continuation application of International Application No. PCT/KR2025/004886, filed on Apr. 10, 2025, in the Korean Intellectual Property Receiving Office, which claims priority to Korean Patent Application No. 10-2024-0057754, filed on Apr. 30, 2024, in the Korean Intellectual Property Office, and Korean Patent Application No. 10-2024-0131036, filed on Sep. 26, 2024, in the Korean Intellectual Property Office, the disclosures of which are incorporated by reference herein in their entireties.

### BACKGROUND

### 1. Field

The disclosure relates to a dishwasher, and more particularly, to a dishwasher including a capacitive deionization filter.

### 2. Description of Related Art

A dishwasher is a device that sprays water at high pressure onto stored dishes, washes the dishes, and then dries the dishes. The dishwasher sprays the water at high pressure into a tub where the dishes are stored, and the sprayed water comes into contact with the dishes, thereby washing away foreign substances such as food residue on a surface of the dishes.

The dishwasher includes a filter device to soften the water supplied to the dishwasher. When the water flows into the filter device, a water pressure of the water supplied into the dishwasher decreases, which may reduce a flow rate of water supplied into the tub or may cause un-softened water to be supplied into the tub.

### SUMMARY

Provided is a dishwasher including a capacitive deionization filter capable of increasing a flow rate of water flowing into an inside of a tub.

According to an aspect of the disclosure, a dishwasher includes: a tub; a sprayer disposed in the tub and configured to spray water; a sump configured to receive the water supplied to the sprayer before the water is supplied to the sprayer; a capacitive deionization filter configured to filter the water supplied from a water source before the water is supplied to the sump; a case brake configured to allow the water passing through the capacitive deionization filter to flow to the sump and prevent the water from flowing back toward the capacitive deionization filter after the water has entered the case brake from the capacitive deionization filter; a tank configured to store the water after the water is passed through the capacitive deionization filter; a first flow path connecting the capacitive deionization filter and the tank; a second flow path connecting the capacitive deionization filter and the case brake; a third flow path connecting the tank and the sump; and a fourth flow path connecting the case brake and the sump.

A portion of the water passing through the capacitive deionization filter may flow into the sump through the first flow path, the tank, and the third flow path. Another portion of the water passing through the capacitive deionization filter may flow into the sump through the second flow path, the case brake, and the fourth flow path.

The dishwasher may further include a valve configured to: open the first flow path and close the second flow path to allow the water passing through the capacitive deionization filter to be stored in the tank through the first flow path; and close the first flow path and open the second flow path to allow the water passing through the capacitive deionization filter to flow to the sump through the second flow path, the case brake, and the fourth flow path.

The dishwasher may further include least one processor configured to: control the valve to open the first flow path to allow the water passing through the capacitive deionization filter to be stored in the tank before the water is sprayed through the sprayer; and control the valve to open the second flow path to allow the water passing through the capacitive deionization filter to flow to the case brake in response to the water being sprayed by the sprayer.

The at least one processor may be further configured to allow the water stored in the tank and the water passing through the case brake may flow to the sump through the third flow path and the fourth flow path, respectively, in response to the water being sprayed by the sprayer.

The dishwasher may further include a pump configured to allow the water stored in the tank to flow into the sump through the third flow path. The at least one processor may be further configured to drive the pump and open the valve so that the water stored in the tank and the water passing through the case brake may flow to the sump through the third flow path and the fourth flow path, respectively, in response to the water being sprayed through the sprayer.

The at least one processor may be further configured to drive the pump to prevent the water remaining in the tank from flowing to the sump through the third flow path before the water is sprayed through the sprayer.

The at least one processor may be further configured to: control the valve to open the first flow path based on a cycle in which the water is sprayed through the sprayer; and control the valve to close the first flow path and open the second flow path based on a predetermined amount of the water being stored in the tank.

The at least one processor may be further configured to control the valve to allow an amount of the water corresponding to the predetermined amount of the water being stored in the tank to flow to the case brake through the second flow path.

Based on the water, which passes through the capacitive deionization filter, flowing to the sump through the fourth flow path as the valve opens the second flow path, the at least one processor may be further configured to drive the pump to cause the water stored in the tank to flow to the sump through the third flow path.

The at least one processor may be further configured to: control the valve to allow a portion of the water passing through the capacitive deionization filter to be first stored in the tank and to allow another portion of the water passing through the capacitive deionization filter to flow to the case brake after a predetermined amount of water is stored in the tank; and drive the pump to cause the water stored in the tank and the water passing through the case brake to flow simultaneously to the sump.

The capacitive deionization filter may include a first capacitive deionization filter and a second capacitive deionization filter connected in series with the first capacitive deionization filter.

The capacitive deionization filter may include a first capacitive deionization filter and a second capacitive deionization filter connected in parallel with the first capacitive deionization filter.

The dishwasher may further include a backflow prevention valve on a flow path connecting the water source and the capacitive deionization filter and configured to prevent the water passing through the capacitive deionization filter from flowing back toward the water source after the water has passed through the capacitive deionization filter.

The case brake may include an air brake having a siphon shape and configured to prevent the water from flowing back toward the capacitive deionization filter after the water has entered the case brake from the capacitive deionization filter, and
wherein the air brake comprises an air brake hole configured to allow a flow path inside the case brake to be opened to an outside to allow the flow path, through which the water flows, inside the case brake to be connected to the outside.

In a state in which the water exceeds a predetermined hydraulic pressure of flow rate and flows into the case brake, the air brake may be configured to allow the water to move to the tub through the air brake.

The case brake may include: a case forming an internal path; an inlet configured to allow the water, which has passed through the capacitive deionization filter, to flow into the case and to the air brake; and an outlet configured to allow the water, which has passed through the internal path of the case brake and through the air brake, to be discharged from the case to the sump.

The dishwasher may further include a controller configured to control the amount of the water collected in the sump or sprayed by the sprayer. The case may include a flow meter configured to measure a flow rate of the water passing through the case from the capacitive deionization filter and transmit electrical signals or data corresponding to the measured flow rate of the water passing through the case to the controller. The controller may be further configured to control the amount of the water collected in the sump or sprayed by the sprayer based on the measured flow rate of the water passing through the case.

According to another aspect of the disclosure, a dishwasher includes: a tub; a sprayer disposed in the tub and configured to spray water; a sump; a filter configured to filter the water; a case brake; a tank; a first flow path connecting the filter and the tank; a second flow path connecting the filter and the case brake; a third flow path connecting the tank and the sump; and a fourth flow path connecting the case brake and the sump. A water source supplies the water to the filter and the water flows from the filter to at least one of the case brake or the tank. The water flows from at least one of the case brake or the tank to the sump. The water flows from the sump to the sprayer.

According to another aspect of the disclosure, a dishwasher includes: a tub; a sprayer disposed in the tub and configured to spray water; a sump configured to receive the water supplied to the sprayer before the water is supplied to the sprayer; a capacitive deionization filter configured to filter the water supplied from a water source before the water is supplied to the sump; a case brake downstream from the capacitive deionization filter and configured to allow the water passing through the capacitive deionization filter to flow to the sump and including an air brake configured to prevent the water from flowing back toward the capacitive deionization filter after the water has entered the case brake from the capacitive deionization filter; a tank downstream from the capacitive deionization filter and configured to store the water after the water is passed through the capacitive deionization filter; a first flow path connecting the capacitive deionization filter and the tank; a second flow path connecting the capacitive deionization filter and the case brake; a third flow path connecting the tank and the sump; and a fourth flow path connecting the case brake and the sump. The case brake is configured to supply the water to the sump within a predetermined period of time or the case brake and the tank are configured to supply the water to the sump simultaneously within the predetermined period of time.

By softening water and storing a portion of the softened water in a tank before a washing cycle, and by using the softened and stored water in the washing cycle, a dishwasher including a capacitive deionization filter may prevent a decrease in a flow rate of water that may occur due to the capacitive deionization filter.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a side cross-sectional view of a dishwasher according to one or more embodiment;

FIG. 2 is a view illustrating one side of a tub in which some components of the dishwasher according to one or more embodiments are removed;

FIG. 3 is a perspective view illustrating some components of the dishwasher according to one or more embodiments;

FIG. 4 is a block diagram illustrating a flow of water in the dishwasher according to one or more embodiments;

FIG. 5 is a view illustrating some components of the dishwasher according to one or more embodiments.

FIG. 6 is a control block diagram of the dishwasher according to one or more embodiments;

FIG. 7 is a block diagram illustrating a flow of water in the dishwasher according to one or more embodiments;

FIG. 8 is a block diagram illustrating a flow of water in the dishwasher according to one or more embodiments;

FIG. 9 is a block diagram illustrating a flow of water in a dishwasher according to one or more embodiments; and

FIG. 10 is a view illustrating some components of the dishwasher according to one or more embodiments.

### DETAILED DESCRIPTION

Embodiments described in the disclosure and configurations shown in the drawings are merely examples of the embodiments of the disclosure, and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, numbers, steps, operations, elements, components, or combinations thereof.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of “and/or” includes a plurality of combinations of relevant items or any one item among a plurality of relevant items.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In this disclosure, the meaning of “identical” may include things being similar in properties to each other or are similar within a certain range. In addition, the meaning “identical” refers to “substantially identical”. It should be understood that the meaning of “substantially identical” refers to a value that falls within an error range in manufacturing or a value having a difference within a range that does not have significance with respect to a reference value.

In the following description, terms such as “unit”, “part”, “block”, “member”, and “module” indicate a unit for processing at least one function or operation. For example, those terms may refer to at least one process processed by at least one hardware such as Field Programmable Gate Array (FPGA), Application Specific Integrated Circuit (ASIC), at least one software stored in a memory or a processor.

In the following detailed description, the terms of “front side”, “rear side”, “left side”, “right side” and the like may be defined by the drawings, but the shape and the location of the element is not limited by the term.

Hereinafter for the convenience of description, a dishwasher is illustrated as an example, but the present disclosure may not be limited to a dishwasher. For example, the present disclosure may also be applied to a shoe care apparatus for caring shoes.

The disclosure will be described more fully hereinafter with reference to the accompanying drawings.

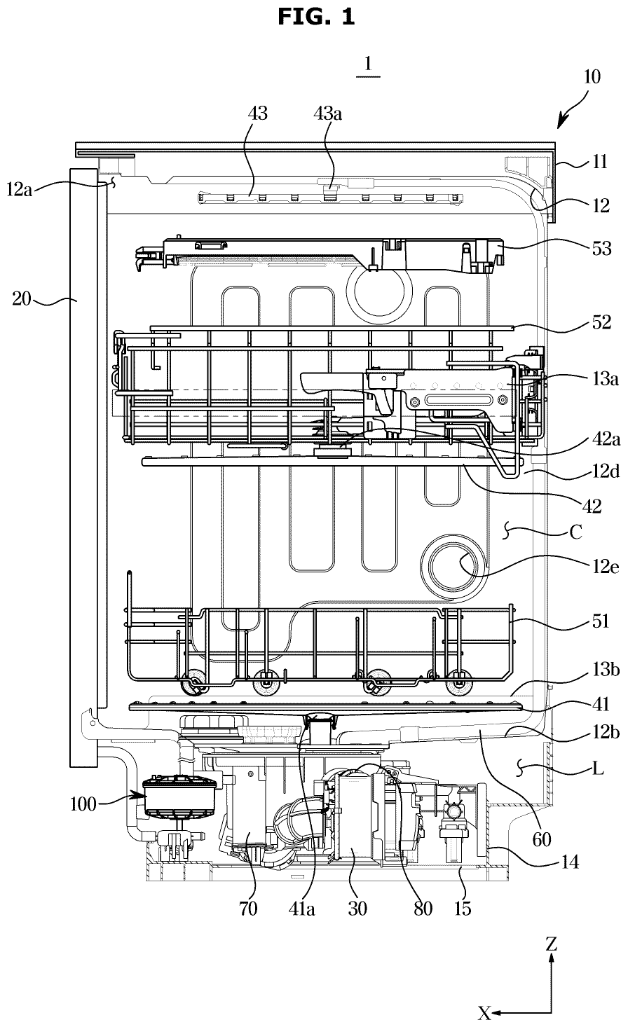

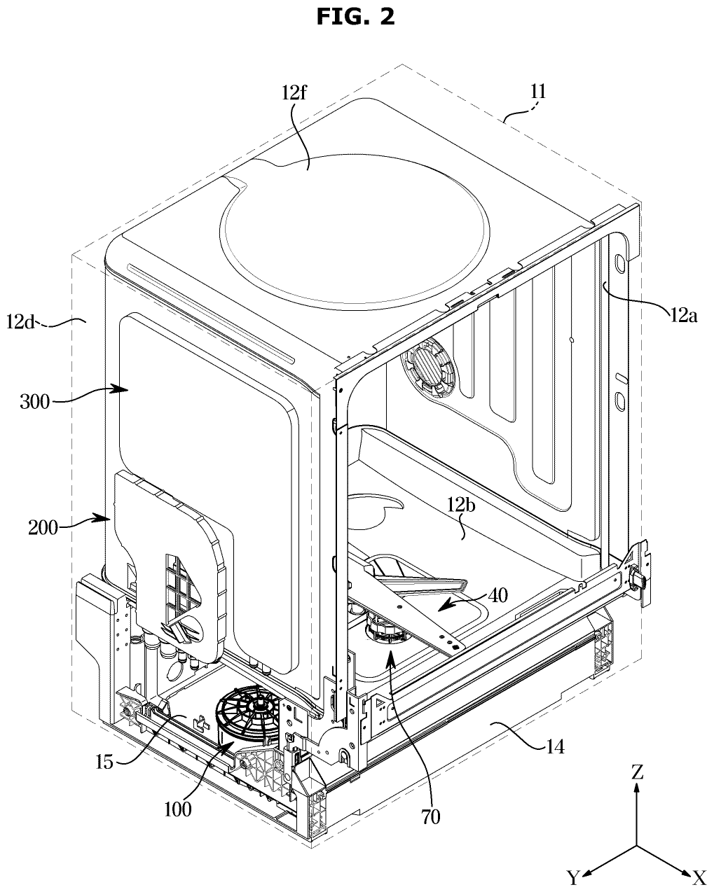

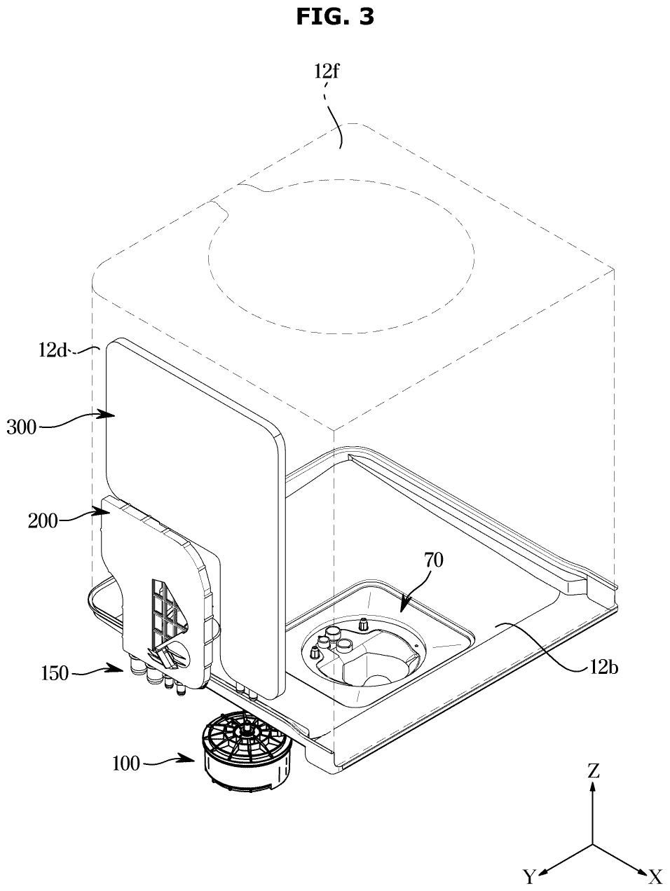

FIG. 1 is a side cross-sectional view of a dishwasher according to one or more embodiments, FIG. 2 is a view illustrating one side of a tub in which some components of the dishwasher according to one or more embodiments are removed, and FIG. 3 is a perspective view illustrating some components of the dishwasher according to one or more embodiments.

Referring to FIGS. 1 to 3, a dishwasher 1 may include a main body 10 forming an exterior of the dishwasher 1. The main body 10 may include a cabinet 11 forming the exterior of the dishwasher 1, and a tub 12 disposed inside the cabinet 11. The tub 12 may be formed in a substantially box shape. One surface of the tub 12 may be opened. The tub 12 may include an opening 12a. For example, a front surface of the tub 12 may be opened.

The dishwasher 1 may further include a door 20 configured to open and close the opening 12a of the tub 12. The door 20 may be installed in the main body 10 to open and close the opening 12a of the tub 12. The door 20 may be rotatably installed to the cabinet 11.

The dishwasher 1 may further include a storage container arranged in the tub 12 to accommodate dishes. The storage container may include a plurality of baskets 51, 52 and 53. Relatively large dishes may be stored in the plurality of baskets 51, 52 and 53. However, the types of dishes accommodated in the plurality of baskets 51, 52 and 53 are not limited to relatively large dishes. That is, the plurality of baskets 51, 52 and 23 may accommodate not only relatively large dishes but also relatively small dishes.

The plurality of baskets 51, 52 and 53 may include an intermediate basket 52 positioned in the middle with respect to the height direction of the dishwasher 1, and a lower basket 51 positioned in a lower portion with respect to the height direction of the dishwasher 1. The intermediate basket 52 may be provided to be supported by an intermediate guide rack 13b. The lower basket 51 may be provided to be supported by a lower guide rack 13a. The intermediate guide rack 13b and the lower guide rack 13a may be installed on an inner surface of a side wall 12d of the tub 12 so as to be slidable toward the opening 12a of the tub 12.

The plurality of baskets 51, 52 and 53 may include an upper basket 53 positioned in an upper portion with respect to the height direction of the dishwasher 1. The upper basket 53 may be formed in a rack assembly to accommodate relatively small dishes. For example, it is appropriate that a cooking utensil such as a ladle, a knife, or a turner, or cutlery are accommodated in the upper basket 53. In addition, a small cup such as an espresso cup may be accommodated in the rack assembly. However, the types of dishes accommodated in the upper basket 53 are not limited thereto.

The dishwasher 1 may include a sump 70 provided to store water. The dishwasher 1 may include a washing chamber C which is a space formed inside the tub 12. The washing chamber C may be a space in which dishes stored in the plurality of baskets 51, 52, and 53 are washed by water and dried. The washing chamber C may be defined as an inner surface of the tub 12 formed by an upper wall 12f, the side wall 12d, a front wall, a rear wall 12c, a bottom 12b and the sump 70 provided to communicate with the bottom 12b.

The dishwasher 1 may include a plurality of sprayers 41, 42, and 43 configured to spray water. The plurality of sprayers 41, 42, and 43 may include a first sprayer 41 arranged under the lower basket 51 in the height direction of the dishwasher 1, a second sprayer 42 arranged under the intermediate basket 52 in the height direction of the dishwasher 1, and a third sprayer 43 arranged above the upper basket 53 in the height direction of the dishwasher 1.

The first sprayer 41 may be configured to be rotatable about a first rotating shaft 41a, the second sprayer 42 may be configured to be rotatable about a second rotating shaft 42a, and the third sprayer 43 may be configured to be rotatable about a third rotating shaft 43a.

However, the present disclosure is not limited to one or more embodiments, and the first sprayer 41 may be fixedly provided on one side of the bottom 12b unlike the second sprayer 42 and the third sprayer 43. At this time, the first sprayer 41 may be configured to spray the water in a substantially horizontal direction by a fixed nozzle. A direction of the water, which is sprayed in a substantially horizontal direction from the nozzle of the first sprayer 41, may be changed by a conversion assembly arranged thereon and then the water may move upward.

The third sprayer 43 may spray water toward dishes stored in the upper basket 53, the intermediate basket 52, and the lower basket 51, and the second sprayer 42 may spray water toward dishes stored in the intermediate basket 52 and the upper basket 53. Unlike the second sprayer 42 and the third sprayer 43, the first sprayer 41 may be coupled to the bottom 12b of the tub. Particularly, the first sprayer 41 may be provided to be fixed to the sump 70.

The dishwasher 1 may include a circulation pump 30 configured to pump water stored in the sump 70 to the sprayers 41, 42 and 43. Water pumped by the circulation pump 30 may be supplied to the first sprayer 41 through an alternating device 80 connected to the circulation pump 30 or may be moved upward by a duct 60 and supplied to the second sprayer 42 or the third sprayer 43.

Water stored in the sump 70 may be supplied to the alternating device 80 by the circulation pump 30. The alternating device 80 may supply water to the first sprayer 41 through a connector connected to the first sprayer 41, and may supply water to the duct 60 through a flow path connected to the duct 60.

The alternating device 80 may selectively supply water to at least one of the connector and the duct 60. The alternating device 80 may be disposed in a machine room L provided below the washing chamber C.

The dishwasher 1 may include the machine room L arranged under the tub 12. The machine room L may be formed by a lower frame 14 and a bottom plate 15. The above-described circulation pump 30, sump 70, alternating device 80, etc. may be arranged in the machine room L, and a water supply hose and a drain hose, which will be described later, may be arranged in the machine room L.

The dishwasher 1 may include a case brake 200 coupled to the side wall 12d of the tub 12. For example, the case brake 200 may be coupled to an outer side wall of the tub. Additionally, the case brake 200 may be positioned at a lower portion of the outer side wall of the tub 12. The case brake 200 may receive water from a filter assembly 100 to be described later. The case brake 200 may guide water to the sump 70.

The dishwasher 1 may include a tank 300 coupled to the side wall 12d of the tub 12 together with the case brake 200. The tank 300 may be provided to temporarily store water flowing from the filter assembly 100. The tank 300 may be supplied with water from the filter assembly 100. The tank 300 may guide water to the sump 70.

The case brake 200, the tank 300, the sump 70, and the filter assembly 100 are each connected by hoses through which the water flows, but for the convenience of description, these will be omitted in the description. In addition, the hoses are omitted from the drawings.

The case brake 200 is provided to be connected to a communication hole 12e formed in the side wall 12d of the tub 12.

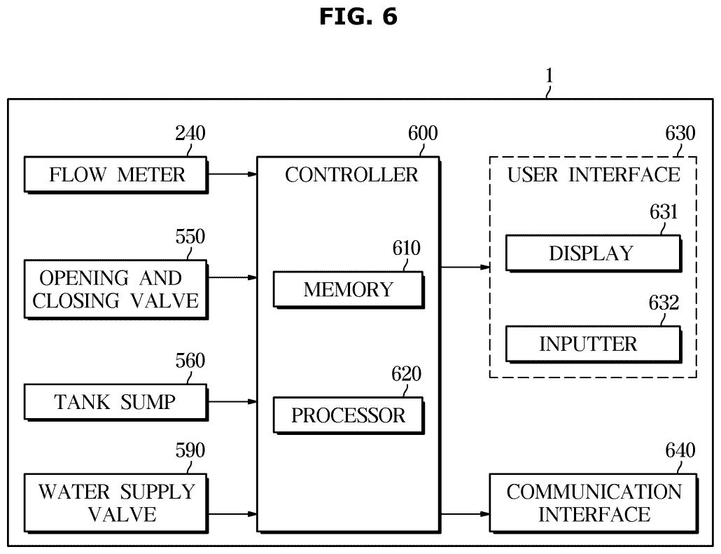

The case brake 200 may be configured to detect an amount of water supplied into the dishwasher 1. The case brake 200 may include a flow meter 240 configured to detect the amount of water flowing into the case brake 200 (refer to FIG. 6).

The case brake 200 may prevent water, which passes through the case brake 200, from flowing back to the filter assembly 100 connected to the case brake 200. The case brake may include an air brake configured to prevent the water from flowing back to the filter assembly 100.

The air brake may include an air brake hole provided to allow a flow path inside the case brake 200 to be opened to the outside to allow the flow path, through which the water flows, inside the case brake 200 to be connected to the outside.

Through the air brake hole, the inside of the case brake 200 and/or the internal flow path and the atmosphere may be pressure balanced.

The air brake may be provided to prevent the water from flowing back caused by the siphon shape when the water supply is stopped.

When water, which exceeds a predetermined hydraulic pressure or flow rate, flows into the case brake 200, the air brake may be configured to allow the water to be moved to the tub 12 through the air brake.

The case brake 200 may include a case 210 forming an internal path, an inlet 220 provided to allow water softened by the filter assembly 100 to flow into the case 210, and an outlet 230 provided to allow water to pass through the internal path of the case brake 200 and be discharged from the case 210.

Water flowing into the case 210 through the inlet 220 may move to the air brake and water, which passes through the air brake, may move to the outlet 230 to be discharged to the sump 70.

The flow meter 240 may be disposed in the case 210. Because the water passing through the filter assembly 100 flows into the case brake 200, the flow meter 240 inside the case brake 200 may measure a flow rate after passing through the filter assembly 100. Because water is supplied directly to the sump 70 after passing through the case brake 200, an amount of water equal to a flow rate value measured by the flow meter 240 may be supplied to the sump 70.

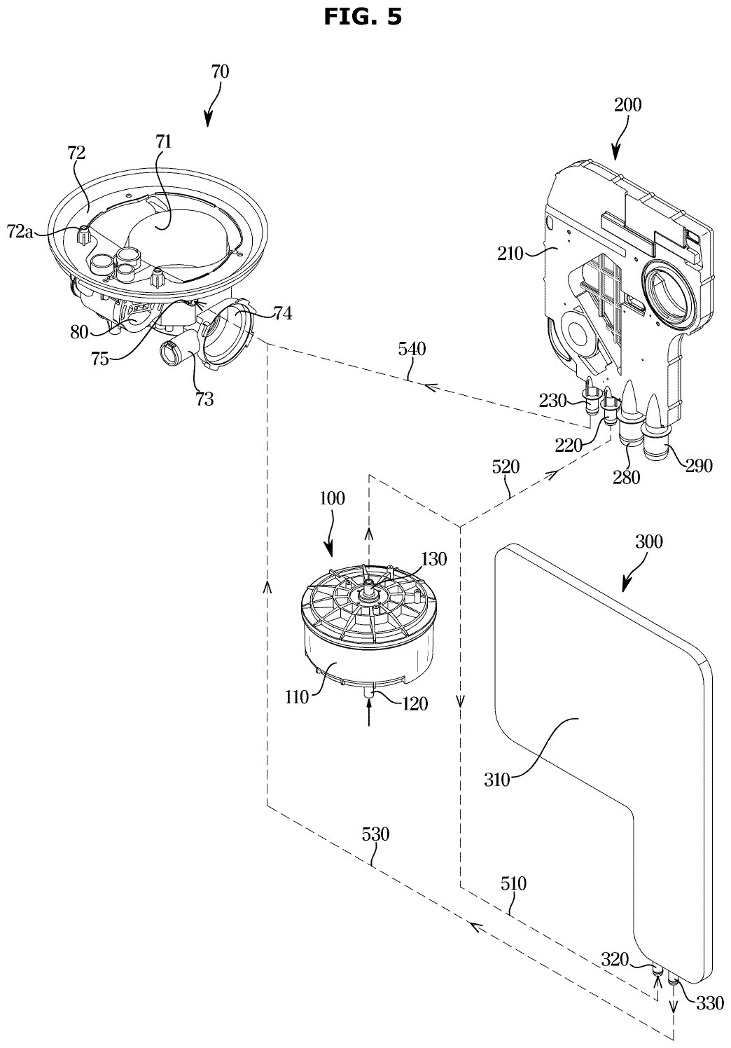

There may be almost no error between the amount measured by the flow meter 240 and the amount in a sump collecting portion 71 of the sump 70 (refer to FIG. 5).

The flow meter 240 may transmit electrical signals and/or data corresponding to the measured amount to the controller 600. The controller 600 may regulate an amount of water collected in the sump 70 or sprayed into the washing chamber C based on the signals and/or data received from the flow meter 240.

The case brake 200 may include a sump drain connector 280 into which water drained from the sump 70 is introduced, and a drain connector 290 provided to allow water, which is introduced into the case 210 through the sump drain connector 280, to be drained to the outside. The drain connector 290 may be connected to the outside through a hose.

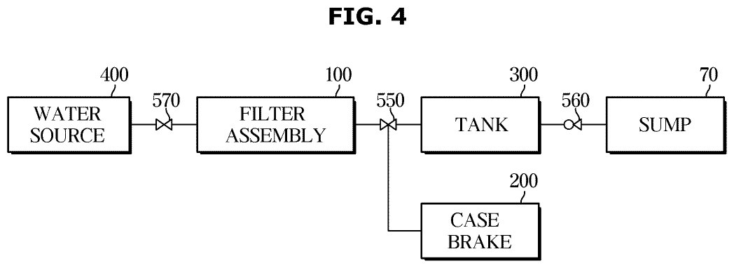

The dishwasher 1 may include the filter assembly 100 configured to filter water supplied from the outside to the sump 70. The filter assembly 100 may be supplied with water from an external water source 400 (refer to FIG. 4).

The filter assembly 100 may be arranged on the upstream side of the case brake 200 to allow the softened water to flow to the case brake 200. The filter assembly 100 may be arranged on the lower side of the tub 12.

The filter assembly 100 may be disposed in the machine room L. For example, a part of the filter assembly 100 may be disposed under the bottom 12b of the tub. The filter assembly 100 may be accommodated in the cabinet 11.

The filter assembly 100 is disposed inside the cabinet 11 and thus even when the water leaks out of the filter assembly 100, the water may not leak outside the cabinet 11.

The filter assembly 100 may be provided as a capacitive deionization (CDI) device.

The filter assembly 100 may be configured to apply a charge to two electrodes to remove ions from water flowing between the two electrodes by adsorbing the ions onto the electrodes, and to reverse the electrode voltage to desorb the ions adsorbed onto the electrodes from the electrodes, thereby softening water.

The filter assembly 100 may include a case 110 in which electrodes are disposed, an inlet 120 through which water flows into the case 110, and an outlet 130 through which water flowing between the electrodes is discharged.

A capacitive deionization unit provided with a plurality of electrodes for deionizing water and an electrode for applying a voltage to the plurality of electrodes may be mounted to the inside of the case 110.

The inlet 120 may be disposed on one side of the case 110 and the outlet 130 may be disposed on the other side of the case 130, but there is no limitation on the positions of the inlet 120 and the outlet 130.

A distributing portion connected to the inlet 120 may be disposed in the case 110, and the water flowing into the case 110 through the inlet 120 may be deionized while flowing between the plurality of electrodes through the distributing portion.

Ionic substances in the water flowing between the plurality of electrodes may be adsorbed on the plurality of electrodes, and the water passing through the plurality of electrodes may be softened by removing the ionic substances from the raw water.

The capacitive deionization unit may include the plurality of electrodes, a plurality of ion exchange membranes corresponding thereto, and a plurality of spacers. The capacitive deionization unit may be formed by stacking the plurality of electrodes, the plurality of ion exchange membranes, and the plurality of spacers in a certain order.

Each of the electrode, the ion exchange membrane, and the spacer may be provided in the form of a thin plate or sheet. In addition, each of the electrode, the ion exchange membrane, and the spacer may form a hollow space on the inside thereof.

The plurality of electrodes may include a first electrode and a second electrode, and one surface of the first electrode and one surface of the second electrode may be arranged to face each other. One of one surface of the first electrode and one surface of the second electrode may act as an anode, and the other surface thereof may act as a cathode. Accordingly, an electric field may be formed between the first electrode and the second electrode.

The ion exchange membrane may include a cation exchange membrane and an anion exchange membrane. The cation exchange membrane may be configured to allow only cations to pass through, and the anion exchange membrane may be configured to allow only anions to pass through. The cation exchange membrane may be attached to one surface of the second electrode acting as a cathode, and the anion exchange membrane may be attached to one surface of the first electrode acting as an anode. However, the ion exchange membrane may be omitted.

The spacer may be disposed between the cation exchange membrane and the anion exchange membrane. The spacer may be provided to allow water to pass through the inside. For example, the spacer may include a mesh material. However, there is no limitation on the material of the spacer.

Water may flow between the plurality of electrodes while passing through the spacer, and at this time, cations contained in the water may be adsorbed on one surface of the second electrode acting as a cathode, and anions contained in the water may be adsorbed on one surface of the first electrode acting as an anode.

The sump 70 may include the collecting portion 71, a seating portion 72, a drain portion 73, a drain pump coupling portion 74, and a sump inlet portion 75 (refer to FIG. 5).

The collecting portion 71 may collect water that passes through the filter assembly 100 and the case brake 200 in sequence. In addition, the collecting portion 71 may collect water that sequentially passes through the filter assembly and the tank 300 to be described later.

The collecting portion 71 may be opened to collect water. The collecting portion 71 may be an opening of the sump 70. The tub bottom 12b may be installed in the seating portion 72. The tub 12 may be coupled to the sump 70.

The drain portion 73 may be provided to drain water collected in the collecting portion 71. The drain portion 73 may allow water to flow to the sump drain connector 280 of the case brake 200 through a drain hole. Water flowing into the case brake 200 through the sump drain connector 280 may be discharged to the outside through the drain connector 290.

A check valve may be disposed in the drain portion 73. The check valve may prevent water from flowing backwards. The check valve may be connected to one end of a drain pipe.

The sump inlet portion 75 may be provided to allow the water, which passes through the filter assembly 100 and the case brake 200 in sequence, to be collected in the sump 70. In addition, the inlet portion 75 may be provided to allow the water, which passes through the filter assembly and the tank 300 in sequence, to be collected in the sump 70.

The sump inlet portion 75 may be connected to a separate hose, which is connected to the outlet 230 of the case brake 200, and thus the water in the case brake 200 may be connected to the sump 70 through the sump inlet portion 75, and the water may be collected in the collecting portion 71. A drain pump that pumps water to drain the water collected after a washing cycle may be connected to the drain pump coupling portion 74.

The dishwasher 1 may include the tank 300 in which water that passes through the filter assembly 100 is stored.

The tank 300 may be provided to allow the water passing through the filter assembly 100 to be temporarily stored and then to flow to the sump 70.

The tank 300 may include a case 310, an inlet 320 through which water flows into the case 310, and an outlet 330 through which water flowing in through the inlet 320 is discharged (refer to FIG. 5).

A portion of the water passing through the filter assembly 100 may flow into the tank 300 and other portion thereof may flow into the case brake 200. This will be described in detail later.

The inlet 320 of the tank 300 may be connected to the outlet 130 of the filter assembly 100, and the outlet 330 of the tank 300 may be connected to the sump inlet portion 75 of the sump 70.

The tank 300 may be coupled to the side wall 12d of the tub 12 in which the case brake 200 is disposed. The tank 300 may be coupled to the outer side wall of the tub to which the case brake 200 is coupled.

The tank 300 may be disposed on a surface of the side wall 12d of the tub 12 on which the case brake 200 is not located.

As the tank 300 and the case brake 200 are disposed on the same side of the tub 12, a space between the tub 12 and the cabinet 11 may be minimized.

A width of the tank 300 from the outer surface of the tub toward the cabinet 11 may be set to approximately correspond to a width of the case brake 200 from the outer surface of the tub toward the cabinet 11. This is to maximize a capacity of the case brake 200 and the tank 300 in the space between the tub 12 and the cabinet 11 where the case brake 200 and the tank 300 are placed.

Hereinafter the flow of water according to a connection relationship among the filter assembly 100, the case brake 200, the tank 300, and the sump 70 is described in detail.

FIG. 4 is a block diagram illustrating a flow of water in the dishwasher according to one or more embodiments, FIG. 5 is a view illustrating some components of the dishwasher according to one or more embodiments, and FIG. 6 is a control block diagram of the dishwasher according to one or more embodiments.

As illustrated in FIGS. 4 and 5, the water supplied from the water source 400 may be provided to first pass through the filter assembly 100 and then flow to the case brake 200. Alternatively, the water supplied from the water source 400 may be provided to first pass through the filter assembly 100 and then flow to the case brake 200 or the tank 300.

Water flowing into the case brake 200 or the tank 300 may pass through the case brake 200 or be temporarily stored in the tank 300 and then flow to the sump 70.

The filter assembly 100 may be disposed upstream of the case brake 200.

The water source 400 may be connected to the filter assembly 100, and the filter assembly 100 may be disposed between the water source 400 and the case brake 200 on the flow path to allow water supplied from the water source 400 to pass through the filter assembly 100 and to flow to the case brake 200.

The filter assembly 100 may be arranged so as not to be placed downstream of the case brake 200. Accordingly, the water supplied from the water source 400 may be provided to first pass through the filter assembly 100 and then flow to the case brake 200.

Further, the filter assembly 100 may be arranged upstream of the tank 300. The filter assembly 100 may be provided not to be arranged downstream of the tank 300.

Accordingly, the water supplied from the water source 400 may be provided to first pass through the filter assembly 100 and then flow to the case brake 200 or tank 300.

As described above, the filter assembly 100 is provided as a capacitive deionization device, and as the water introduced into the case 110 of the filter assembly 100 flows along the space between the plurality of electrodes provided inside the case 110, a large differential pressure may occur between water at the inlet 120 and water at the outlet 130 of the filter assembly 100.

Accordingly, when the filter assembly 100 is disposed downstream of the case brake 200 and the water supplied from the water source 400 flows to the filter assembly 100 through the case brake 200, a portion of the water flowing into the case brake 200 may be discharged into the tub 12 through the air brake inside the case 210 due to the differential pressure of the water generated in the filter assembly 100. As for the water flowing out from the case brake 200 to the tub 12, the water that does not pass through the filter assembly 100 may not be softened and thus the softening efficiency of the water stored in the sump 70 may be reduced.

To prevent this, the filter assembly 100 may be provided to be disposed upstream of the case brake 200, and the water supplied from the water source 400 may be provided to flow to the case brake 200 after passing through the filter assembly 100.

Because the filter assembly 100 is provided as a capacitive deionization device, a flow rate of the water passing through the filter assembly 100 may be reduced in comparison with other types of filter devices. The flow rate of the water passing through the filter assembly 100 may be less than other types of filter devices with respect to a predetermined period of time.

Accordingly, when an operation of spraying water through the spraying units 41, 42, and 43 is in progress in the dishwasher 1, a flow rate that is required for spraying water may not be supplied to the sump 70 within a predetermined period of time.

To prevent this, the dishwasher 1 may be configured to allow water supplied from the water source 400 to pass through the filter assembly 100 and to be temporarily stored in the tank 300 before performing the operation of spraying the water through the sprayers 41, 42 and 43.

While the dishwasher 1 performs the operation in which water is sprayed through the sprayers 41, 42 and 43, the dishwasher 1 may be configured to allow the water, which is stored in the tank 300, and water, which is supplied from the water source 400 and passes through the filter assembly 100 and the case brake 200, to flow simultaneously to the sump 70, and thus the dishwasher 1 may be configured to supply the required flow rate for spraying the water may be supplied to the sump 70 within the predetermined period of time.

The dishwasher 1 may include a first flow path 510 connecting the filter assembly 100 and the tank 300 and a second flow path 520 connecting the filter assembly 100 and the case brake 200.

Water passing through the filter assembly 100 may be provided to flow through the first flow path 510 or the second flow path 520 and flow to the tank 300 or the case brake 200.

The dishwasher 1 may include a third flow path 530 connecting the tank 300 and the sump 70 and a fourth flow path 540 connecting the case brake 200 and the sump 70.

The third flow path 530 and the fourth flow path 540 may be provided to allow the water to independently flow to the sump 70.

The first to fourth flow paths 510, 520, 530 and 540 may all be formed with hoses or pipes that allow the water to flow, but are not limited thereto.

The first flow path 510 and the second flow path 520 may each be independently connected to the outlet 130 of the filter assembly 100. The first flow path 510 and the second flow path 520 may each be provided to branch off from a flow path connected to the filter assembly 100.

The third flow path 530 and the fourth flow path 540 may each be independently connected to the sump inlet portion 75 of the sump 70. The third flow path 530 and the fourth flow path 540 may each be provided to be connected to a flow path connected to the sump inlet portion 75 of the sump 70.

A portion of water passing through the filter assembly 100 may flow into the sump 70 through the first flow path 510, the tank 300, and the third flow path 530.

Other portion of the water passing through the filter assembly 100 may flow into the sump 70 through the second flow path 520, the case brake 200, and the fourth flow path 540.

The dishwasher 1 may include a valve (an opening and closing valve) 550 configured to open and close the first flow path 510 or the second flow path 520.

The opening and closing valve 550 may be configured to open the first flow path 510 and close the second flow path 520 to allow the water passing through the filter assembly 100 to be stored in the tank 300 through the first flow path 510.

Conversely, the opening and closing valve 550 may be configured to close the first flow path 510 and open the second flow path 520 to allow the water passing through the filter assembly 100 to flow into the sump 70 through the second flow path 520, the case brake 200, and the fourth flow path 540.

The opening and closing valve 550 may be disposed at a location, in which the first flow path 510 and the second flow path 520 branch off, or at a location, in which the filter assembly 100 and the first and second flow paths 510 and 520 are connected, to open and close the first flow path and the second flow path 520.

The opening and closing valve 550 may be configured to selectively open and close the first flow path 510 and the second flow path 520. The opening and closing valve 550 may be configured to open or close both the first and second flow paths 510 and 520.

Before the water is sprayed through the sprayers 41, 42 and 43, the dishwasher 1 may be configured to allow the opening and closing valve 550 to open the first flow path 510 so as to allow the water passing through the filter assembly 100 to be stored in the tank 100.

When the water is sprayed through the sprayers 41, 42 and 43, the dishwasher 1 may be configured to allow the opening and closing valve 550 to open the second flow path 520 so as to allow the water passing through the filter assembly 100 to flow to the case brake 200.

When water is sprayed through the sprayers 41, 42 and 43, the dishwasher 1 may be configured to allow both water stored in the tank 300 and water discharged from the case brake 200 to flow into the sump 70 through the third flow path 530 and the fourth flow path 540, respectively.

The dishwasher 1 may include a tank pump 560 configured to supply water stored in the tank 300 to the sump 70 to allow the water stored in the tank 300 to flow to the sump 70 through the third flow path 530.

However, the present disclosure is not limited thereto, and the dishwasher 1 may include a tank opening and closing valve configured to supply water stored in the tank 300 to the sump 70 to allow the water stored in the tank 300 to flow to the sump 70 through the third flow path 530 when the tank 300 is positioned higher than the sump 70.

The tank pump 560 may be arranged on the third flow path 530 to allow the water stored in the tank 300 to selectively flow to the sump 70.

When water is moved to the tank 300 as the opening and closing valve 550 opens the first flow path 510 before the water is sprayed through the sprayers 41, 42 and 43, the tank pump 560 may not be driven to allow the water to be stored in the tank 300.

When water is sprayed through the sprayers 41, 42 and 43, the tank pump 560 may be driven to allow water stored in the tank 300 to flow into the sump 70 through the third flow path 530.

Based on a cycle in which water is sprayed through the sprayers 41, 42 and 43, the dishwasher 1 may be configured to allow the opening and closing valve 550 to open the first flow path 510, and based on a predetermined amount of water being stored in the tank 300, the dishwasher 1 may be configured to allow the opening and closing valve 550 to close the first flow path 510 and open the second flow path 520.

The dishwasher 1 may be configured to open and close the opening and closing valve to allow an amount of water corresponding to a predetermined amount of water to flow to the case brake 200 through the second flow path 520.

The dishwasher 1 may be configured to drive the tank pump 560 to allow water stored in the tank 300 to flow to the sump 70 through the third flow path 530 based on the water, which passes through the filter assembly 100 as the opening and closing valve 550 opens the second flow path 520, flowing to the sump 70 through the fourth flow path 540.

When a portion of water passing through the filter assembly 100 is first stored in the tank 300 and when a predetermined amount of water is stored in the tank 300, the dishwasher 1 may be configured to control the opening and closing valve 550 to allow other portion of the water passing through the filter assembly 100 to flow into the case brake 200.

The dishwasher 1 may be configured to control the tank pump 560 to allow both the water stored in the tank 300 and the water passing through the case brake 200 to flow simultaneously into the sump 70.

The dishwasher 1 may include a backflow prevention valve 570 provided on a flow path, which connects the water source 400 and the filter assembly 100, to prevent the water, which flows into the filter assembly 100, from flowing back to the water source 400.

The backflow prevention valve 570 may be positioned upstream of the filter assembly 100.

The case brake 200 may prevent water, which passes through the filter assembly 100, from flowing back into the filter assembly 100 after the water passes through the filter assembly 100 and the backflow prevention valve 570 may prevent water, which flows into the filter assembly 100, from flowing back into the water source 400 after the water passes through the filter assembly 100.

As illustrated in FIG. 6, the dishwasher 1 may include the controller 600. The controller 600 may be electrically connected to the flow meter 140, the opening and closing valve 550, a user interface 630, and a communication interface 640 to control each of the flow meter 240, the opening and closing valve 550, the user interface 630, and the communication interface 640. The controller 600 may include a memory 610 and a processor 620.

The controller 600 may be provided in the main body 10, and the user interface 630 may be provided in the door 20. The position of the controller 600 and the position of the user interface 630 are not limited to the above-described examples, and may be placed in various positions.

The memory 610 may store/remember various types of information necessary for the operation of the dishwasher 1. The memory 610 may store instructions, applications, data, and/or programs necessary for the operation of the dishwasher 1. The memory 610 may include a volatile memory such as Static Random Access Memory (S-RAM) or Dynamic Random Access Memory (D-RAM) for temporarily storing data. In addition, the memory 610 may include a nonvolatile memory such as Read Only Memory (ROM), Erasable Programmable Read Only Memory (EPROM), or Electrically Erasable Programmable Read Only Memory (EEPROM) for long-term storage of data.

The processor 620 may generate a control signal for controlling the operation of the dishwasher 1 based on instructions, applications, data and/or programs stored in the memory 610. The processor 620 is hardware and may include logic circuits and operation circuits. The processor 620 may process data according to the program and/or instructions provided from the memory 610 and generate a control signal according to the processing result. The memory 610 and the processor 620 may be implemented as one control circuit or as multiple circuits.

The user interface 630 may include a display 631 and an inputter 632. The display 631 may display information regarding the state and/or operation of the dishwasher 1. The display 631 may display information input by a user or information provided to the user on various screens. The display 631 may display information related to the operation of the dishwasher 1 as at least one of an image or text. In addition, the display 631 may display a graphical user interface (GUI) that allows control of the dishwasher 1. That is, the display 631 may display a user interface (UI) element such as an icon.

The display 631 may include various types of display panels. For example, the display 631 may include a liquid crystal display (LCD) panel, a light emitting diode (LED) panel, an organic light emitting diode (OLED) panel, or a micro-LED panel. Further, the display 631 may be implemented as a touch display.

The inputter 632 may output an electrical signal (voltage or current) corresponding to a user input to the processor 620. The inputter 632 may include various buttons and may also include a dial. When the display 631 is provided as a touch display, a separate inputter 632 may not be provided. For example, the user interface 630 may obtain various user inputs, such as a user input for turning on or off the dishwasher 1 and a user input for selecting a washing course.

The communication interface 640 may include a wired communication module and/or a wireless communication module for communicating with an external device (e.g., a mobile device and a computer). The wired communication module may communicate with the external device via a wide area network such as the Internet, and the wireless communication module may communicate with the external device via an access point connected to the wide area network. Accordingly, a user can remotely control the dishwasher 1.

A plurality of washing courses for the operation of the dishwasher 1 may be provided. For example, various washing courses such as an automatic course, a standard course, a strong course, a quick course, and/or a rinse-dry course may be provided. The number and/or types of cycles included in each washing course may be different. A user can select a washing course using the user interface 630.

The washing course may include at least one cycle. When at least one cycle is performed, water may be sprayed onto dishes placed inside the dishwasher 1. For example, the standard course may include a pre-wash cycle, a main wash cycle, a rinse cycle, and a drying cycle. The pre-wash cycle, the main wash cycle, the rinse cycle, and the drying cycle may be performed sequentially. The types of cycles are not limited to those exemplified.

When a cycle of spraying water, such as the pre-wash cycle and the main wash cycle, is performed, the water may be supplied to the sump 70 through a flow path passing through the water source 400, the filter assembly 100, and the case brake 200, and a flow path passing through the water source 400, the filter assembly 100, and the tank 300.

When the cycle of spraying water, such as the pre-wash cycle and the main wash cycle, is performed, the processor 620 may control a water supply valve 590 configured to allow or block the inflow of water from the water source 400 into the dishwasher 1.

When the cycle of spraying water, such as the pre-wash cycle and the main wash cycle, is performed, the processor 620 may control the opening and closing valve 550. The processor 620 may be configured to control the opening and closing valve 550 to open and close the first flow path 510 or the second flow path 520 so as to allow the water passing through the filter assembly 100 to flow into the first flow path 510 or the second flow path 520.

The processor 620 may control the opening and closing valve 550 to open or close the first flow path 510.

The processor 620 may control the opening and closing valve 550 to open or close the second flow path 520. The opening and closing valve 550 may be provided as a solenoid valve. The solenoid valve may open or close the flow path by moving a plunger connected to a piston.

Based on at least one cycle included in the washing course, the processor 620 may be configured to control the opening and closing valve 550 together with the operation of the water supply valve 590 to open one of the first flow path 510 and the second flow path 520 to allow the water passing through the filter assembly 100 to flow through the first flow path 510 or the second flow path 520.

Before the cycle of spraying water is performed, the processor 620 may control the opening and closing valve 550 to open the first path 510.

In order to allow a predetermined amount of water to be stored in the tank 300 before the cycle of spraying water is performed, the processor 620 may be configured to control the opening and closing valve 550 to open the first path 510 to allow water supplied from the water source 400 to pass through the filter assembly 100 and then flow into the tank 300.

In order to allow water stored in the tank 300 to be temporarily stored in the tank 300 without flowing to the sump 70 before the cycle of spraying water is performed, the processor 620 may be configured to control the tank pump 560 not to be driven.

An operation before the cycle of spraying water is performed may be an operation in which water, which corresponds to half an amount of water required for an operation in which the cycle of spraying water is performed, is temporarily stored in the tank 300 to secure the amount of the water required for the cycle of spraying water.

For this, the processor 620 may control the opening and closing valve 550 to open the first flow path 510 and close the second flow path 520 to allow the water to flow to the tank 300 in which the water may be temporarily stored.

The processor 620 may control the opening and closing valve 550 to close the first flow path 510 and open the second flow path 520 based on the amount of the water, which corresponds to half the amount of the water required for the cycle of spraying water, being stored in the tank 300.

When water supplied from the water source 400 directly flows to the sump 70 through the second flow path 520 and the fourth flow path 540 after the amount of the water, which corresponds to half the amount of the water required for the operation, in which the cycle of spraying water is performed, is secured in the tank 300, the sum of the amount of the water which is supplied from the water source 400 and flows to the sump 70 through the filter assembly 100 and the case brake 200 and the amount of the water simultaneously flowing from the tank 300 to the sump 70 may satisfy the amount of the water required for the operation, in which the cycle of spraying water is performed.

Therefore, when the amount of the water, which corresponds to half the amount of the water required for the cycle of spraying water is stored in the tank 300, the processor 620 may control the opening and closing valve 550 to close the first flow path 510 and open the second flow path 520, and guide water to allow the water flowing in the first flow path 510 to move to the second flow path 520.

When the processor 620 controls the opening and closing valve 550 to open the second flow path 520 so as to allow water supplied from the water source 400 to flow to the sump 70 through the second flow path 520 and the fourth flow path 540, the processor 620 may control the tank pump 560 to allow water stored in the tank 300 to flow simultaneously to the sump 70 through the third flow path 530.

The processor 620 may control the tank pump 560 not to be driven in a state in which the opening and closing valve 550 opens the first flow path 510, and the processor 620 may control the tank pump 560 to be driven in a state in which the opening and closing valve 550 opens the second flow path 520.

Accordingly, the water supplied from the water source 400 in the state in which the opening and closing valve 550 opens the first flow path 510 may be maintained at a state, in which the water does not flow from the tank 300 to the sump 70, so as to be temporarily stored in the tank 300. Further, the opening and closing valve 550 and the tank pump 560 may be controlled to allow the water stored in the tank 300 to flow to the sump 70 together with the water which is supplied from the water source 400 and flows to the sump 70 through the second flow path 520 and the fourth flow path 540 in the state in which the opening and closing valve 550 opens the second flow path 520.

When the cycle of spraying water is performed, the processor 620 may be configured to allow the water stored in the tank 300 and the water passing through the case brake 200 to flow to the sump 70 through the third flow path 530 and the fourth flow path 540, respectively. The processor 620 may be configured to control or drive the tank pump 560 to prevent the water remaining in the tank 300 from flowing to the sump 70 through the third flow path 530 before the cycle of spraying water is performed.

The processor 620 may be configured to control the opening and closing valve 550 to open the first path 510 based on the cycle of spraying water, and to control the opening and closing valve 550 to close the first path 510 and open the second path 520 based on a predetermined amount of water being stored in the tank 300.

The processor 620 may control the opening and closing valve 550 and the water supply valve 590 to allow an amount of water, which corresponds to the predetermined amount of water stored in the tank 300, to flow to the case brake 200 through the second flow path 520.

Based on water, which passes through the filter assembly 100 as the opening and closing valve 550 opens the second flow path 520, flowing into the sump 70 through the fourth flow path 540, the processor 620 may be configured to control the tank pump 560 to allow the water stored in the tank 300 to flow to the sump 70 through the third flow path 530. The water passing through the case brake 200 and the water stored in the tank 300 may flow to the sump 70 simultaneously.

The processor 620 may control the opening and closing valve 550 to allow a portion of the water passing through the filter assembly 100 to be first stored in the tank 300 and to allow other portion of the water passing through the filter assembly 100 to flow to the case brake 200 after the predetermined amount of the water is stored in the tank 300.

The processor 620 may be configured to control the tank pump 560 to allow the water stored in the tank 300 and the water passing through the case brake 200 to flow into the sump 70 simultaneously.

The processor 620 may control the opening and closing valve 550 based on a user input obtained through the user interface 630. Based on the user input, the processor 620 may control the opening and closing valve 550 to open the first flow path 510 so as to allow water to be first stored in the tank 300 through the filter assembly 100 before the cycle of spraying water starts. The processor 620 may control the opening and closing valve 550 and the tank pump 560 to allow the water stored in the tank 300 and the water, which is supplied from the water source 400 and moves to the sump 70 through the filter assembly 100 and the case brake 200 as the opening and closing valve 550 opens the second flow path 520, to move simultaneously to the sump 70 when the cycle of spraying water starts.

When the cycle of spraying water is performed multiple times according to a predetermined cycle during the washing course, the processor 620 may control the opening and closing valve 550, the tank pump 560, and the water supply valve 590 to allow the opening and closing valve 550 to open the first flow path 510 so as to allow water to be first stored in the tank 300 and then to allow the opening and closing valve 550 to open the second flow path 520 so as to allow water passing through the case brake 200 and the water stored in the tank 300 to flow simultaneously to the sump 70.

When the washing course is in progress, the processor 620 may determine an opening time of the first and second flow paths 510 and 520 by the opening and closing valve 550 based on the amount of the water stored in the tank 300. When the washing course is in progress, the processor 620 may determine an operating time of the tank pump 560 based on the amount of the water passing through the second flow path 520.

When the washing course is in progress, the processor 620 may determine the number of times, in which the first and second flow paths 510 and 520 are opened, and the number of times, in which the tank pump 560 is operated, based on the cycle of spraying water.

That is, the processor 620 may control the opening and closing valve 550 and the tank pump 560 based on the amount of the water required for each cycle of spraying water in the washing course of the dishwasher 1.

Hereinafter the arrangement of the filter assembly 100 according to one or more embodiments is described in detail.

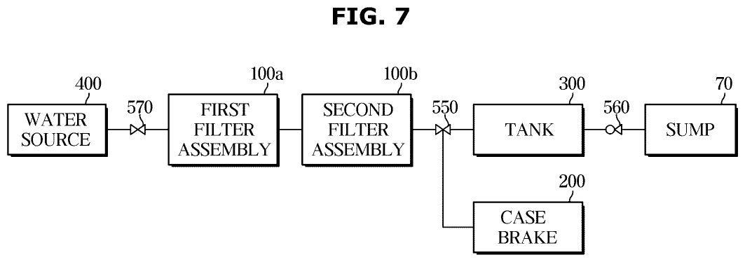

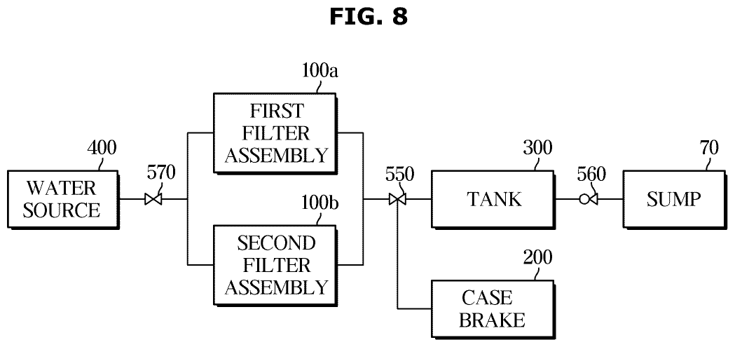

FIG. 7 is a block diagram illustrating a flow of water in the dishwasher according to one or more embodiments. FIG. 8 is a block diagram illustrating a flow of water in the dishwasher according to one or more embodiments.

As described above, because the filter assembly 100 is provided as a capacitive deionization device, the flow rate of the water passing through the filter assembly 100 may be reduced compared to other types of filter devices. With respect to a predetermined period of time, the flow rate of the water passing through the filter assembly 100 may be less than that of other types of filter devices.

Accordingly, the filter assembly 100 may be provided with a plurality of filter assemblies 100 to secure a certain level of the amount of water discharged from the filter assembly 100.

The filter assembly 100 may include a first filter assembly 100a and a second filter assembly 100b connected in series with the first filter assembly 100a, as illustrated in FIG. 7.

As the first filter assembly 100a and the second filter assembly 100b are arranged in series, water supplied from the water source 400 may sequentially pass through the first filter assembly 100a and the second filter assembly 100b.

At this time, because a differential pressure of the water that occurs when passing through one filter assembly is divided into the first filter assembly 100a and the second filter assembly 100b, a differential pressure of the water that occurs when passing through each filter assembly 100a and 100b may be reduced, and because the flow of the water becomes easier as the differential pressure of the water that occurs when passing through each filter assembly 100a and 100b is reduced, the overall flow rate of the water that passes through each filter assembly 100a and 100b may increase.

The filter assembly 100 may include a first filter assembly 100a and a second filter assembly 100b connected in parallel with the first filter assembly 100a, as illustrated in FIG. 8.

As the first filter assembly 100a and the second filter assembly 100b are arranged in parallel, water supplied from the water source 400 may simultaneously pass through the first filter assembly 100a and the second filter assembly 100b.

At this time, because a differential pressure of the water that occurs when passing through one filter assembly is divided into the first filter assembly 100a and the second filter assembly 100b, the differential pressure of the water that occurs when passing through each filter assembly 100a and 100b may be reduced.

As the differential pressure of the water that occurs when simultaneously passing through each filter assembly 100a and 100b and water simultaneously flows to each filter assembly 100a and 100b, the total flow rate of the water that passes through each filter assembly 100a and 100b may increase.

Hereinafter the flow of water according to the connection relationship among the filter assembly 100, the case brake 200, the tank 300, and the sump 70 is described in detail.

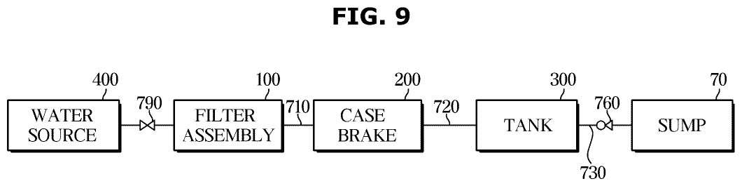

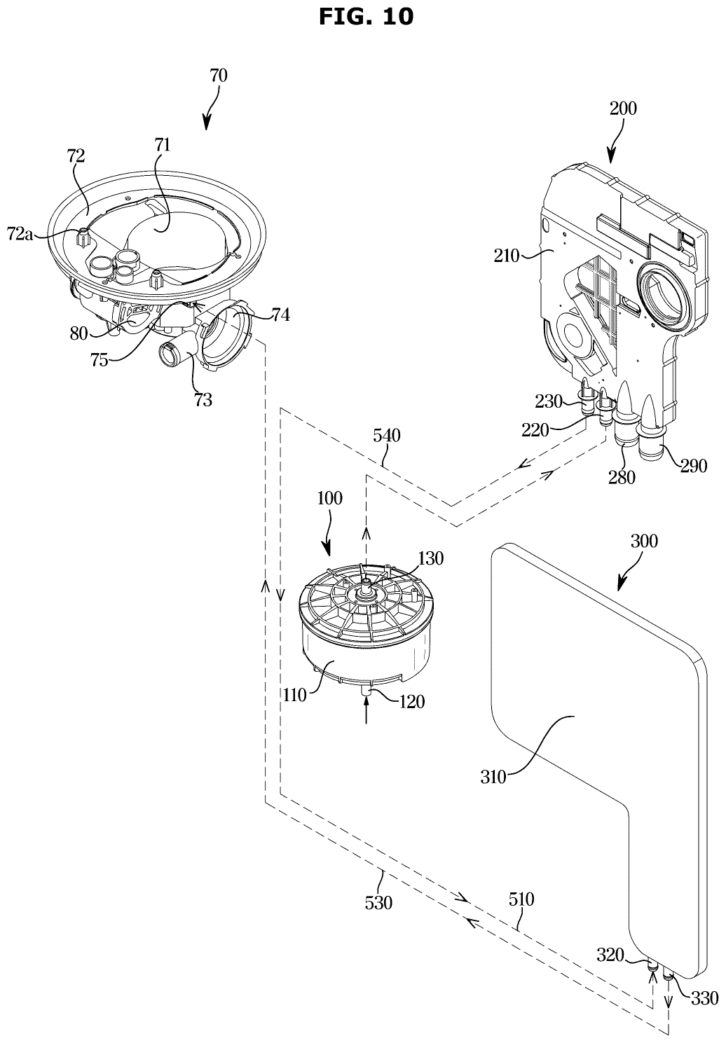

FIG. 9 is a block diagram illustrating a flow of water in a dishwasher according to one or more embodiments, and FIG. 10 is a view illustrating some components of the dishwasher according to one or more embodiments.

A dishwasher 1 may include a filter assembly 100 configured to filter water supplied from a water source 400, a case brake 200 configured to prevent water passing through the filter assembly 100 from flowing backward, and a tank 300 connected to a sump 70 to allow water passing through the case brake 200 to be temporarily stored and to allow the stored water to flow to the sump 70.

The water supplied from the water source 400 may be provided to flow to the sump 70 through the filter assembly 100, the case brake 200, and the tank 300.

The dishwasher 1 may include a first flow path 510 connecting the filter assembly 100 and the case brake 200, a second flow path 520 connecting the case brake 200 and the tank 300, and a third flow path 530 connecting the tank 300 and the sump 70.

When water is supplied from the water source 400, the dishwasher 1 may be configured to allow a predetermined amount of water to be first stored in the tank 300 and then to allow the water to flow to the sump 70.

The dishwasher 1 may include a tank pump 760 configured to allow water stored in the tank 300 to flow to the sump 70 through the third flow path 730.

The dishwasher 1 may be configured to prevent the tank pump 760 from being driven to allow water passing through the case brake 200 to be temporarily stored in the tank 300 when water supply starts from the water source 400. The dishwasher 1 may be configured to drive the tank pump 760 to allow the water stored in the tank 300 to flow to the sump 70 when the predetermined amount of water is stored in the tank 300.

The dishwasher 1 may be configured to drive a water supply valve 790 to allow an amount of water corresponding to an amount of water stored in the tank 300 to be supplied to the dishwasher 1 after the tank pump 760 is operated.

As described above, because the filter assembly 100 is provided as a capacitive deionization device, a flow rate of the water passing through the filter assembly 100 may be less than other types of assemblies with respect to a predetermined period of time. Accordingly, before a cycle of spraying water is performed, the water may be supplied from the water source 400 and the softened water may be temporarily stored in the tank 300. When the cycle of spraying water is performed, the water stored in the tank 300 may flow to the sump 70 while the water is supplied from the water source 400 and flows to the sump 70 by directly passing through the filter assembly 100, the case brake 200, and the tank 300.

It is possible to secure the amount of the water required for the cycle of spraying water, by moving the pre-stored water during the cycle of spraying water.

Before the cycle of spraying water starts, the dishwasher 1 may be configured to allow an amount of water corresponding to half the amount of the water required for the cycle of spraying water to be stored in the tank 300.

During the cycle of spraying water, the dishwasher 1 may be configured to allow an amount of water corresponding to half the amount of the water required for the cycle of spraying water to be supplied to the dishwasher 1 from the water source 400.

Based on at least one cycle included in the washing course, the processor 620 may be configured to control the water supply valve 790 to allow the water supplied from the water source 400 to be stored in the tank 300 through the filter assembly 100, the first flow path 710, the case brake 200, and the second flow path 720.

Before the cycle of spraying water is performed, the processor 620 may control the water supply valve 790 and the tank pump 760 to open the water supply valve 790 and prevent the tank pump 760 from being driven so as to allow the water supplied from the water source 400 to be temporarily stored in the tank 300.

An operation before the cycle of spraying water is performed may be an operation in which water, which corresponds to half the amount of the water required for an operation in which the cycle of spraying water is performed, is temporarily stored in the tank 300 to secure the amount of the water required for the operation in which the cycle of spraying water is performed.

For this, the processor 620 may control the tank pump 760 to limit the flow of water from the tank 300 to the sump 70 to allow the water to be temporarily stored in the tank 300.

The processor 620 may control the tank pump 760 to be driven to allow the water stored in the tank 300 to flow to the sump 70 based on the amount of the water, which corresponds to half the amount of the water required for the cycle of spraying water, being stored in the tank 300.

When an amount of water supplied from the water source 400 corresponds to half the amount of the water required for the cycle of spraying water, based on the amount of the water, which corresponds to half the amount of the water required for the cycle of spraying water, being stored in the tank 300, the processor 620 may control the water supply valve 790 to be closed.

Water may be supplied from the water source 400 even before the cycle of spraying water starts. Accordingly, from when the cycle of spraying water starts, the processor 620 may secure the amount of the water required for the cycle of spraying water, by additionally receiving only half the amount of water required for the cycle of spraying water.

When water supplied from the water source 400 flows to the sump 70 through the filter assembly 100, the case brake 200 and the tank 300 after the amount of the water, which corresponds to half the amount of the water required for the operation, in which the cycle of spraying water is performed, is secured in the tank 300, the sum of the amount of the water which is supplied from the water source 400 and passes through the filter assembly 100 and at least the amount of the water stored in the tank 300 may satisfy the amount of the water required for the operation in which the cycle of spraying water is performed.

Therefore, in order that water corresponding to half the amount of the water required for the cycle of spraying water is pre-stored in the tank 300, the processor 620 may control the water supply valve 790 to be opened and control the tank pump 760 not to be driven before the cycle of spraying water is performed.

When the cycle of spraying water is performed, the processor 620 may control the dishwasher 1 to allow the water stored in the tank 300 to flow to the sump 70 through the third flow path 730 and at the same time, to allow the water continuously supplied from the water source 400 to flow to the tank 300 through the case brake 200.

When the cycle of spraying water is performed, the processor 620 may control the dishwasher 1 to allow the water, which is pre-stored in the tank 300 before the cycle of spraying water, to first flow to the sump 70 by the tank pump 760, and then the water flowing to the tank 300 to flow to the sump 70 from the tank 300.

Based on the cycle of spraying water, the processor 620 may control the water supply valve 790 and the tank pump 760 to allow the tank pump 760 to be driven in a state in which an open state of the water supply valve 790 is maintained.

Based on a predetermined amount of water being stored in the tank 300, the processor 620 may control the water supply valve 790 and the tank pump 760 to allow the tank pump 760 to be driven in the state in which the open state of the water supply valve 790 is maintained.

The processor 620 may control the water supply valve 790 to allow an amount of water corresponding to the predetermined amount stored in the tank 300 to be supplied and to flow to the case brake 200.

The processor 620 may control the water supply valve 790 and the tank pump 760 based on a user input obtained through the user interface 630. Based on the user input, the processor 620 may control the water supply valve 790 and the tank pump 760 to open the water supply valve 790 so as to allow water to be first stored in the tank 300 through the filter assembly 100 before the cycle of spraying water starts. The processor 620 may control the water supply valve 790 and the tank pump 760 to allow the water stored in the tank 300 to move to the sump 70 by the tank pump 760 and at the same time, to allow the water to continuously flow into the filter assembly 100 from the water source 400 when the cycle of spraying water starts.

When the cycle of spraying water is performed multiple times according to a predetermined cycle during the washing course, the processor 620 may control the tank pump 760 and the water supply valve 790 to allow water to be first stored in the tank 300 in each cycle, and when a predetermined amount of water is stored in the tank 300, to allow the water stored in the tank 300 to flow to the sump 70.

The processor 620 may determine an operating time of the tank pump 760 based on the amount of the water stored in the tank 300 when the washing course is in progress. The processor 620 may determine an opening time of the water supply valve 790 based on the amount of the water passing through the filter assembly 100 when the washing course is in progress.

For example, the dishwasher 1 may include a resistance valve disposed on the second flow path 720 and configured to allow only a predetermined amount of water flowing from the case brake 200 to the tank 300 to pass through. This is to allow an amount, which is smaller than the amount of water flowing from the water supply valve 790, to periodically flow into the tank 300.

While the disclosure has been illustrated and described with reference to one or more embodiments, it will be understood that the one or more embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiments described herein may be used in conjunction with any other embodiments described herein.

What is claimed is:

1. A dishwasher comprising:
a tub;
a sprayer disposed in the tub and configured to spray water;
a sump configured to receive the water supplied to the sprayer before the water is supplied to the sprayer;
a capacitive deionization filter configured to filter the water supplied from a water source before the water is supplied to the sump;
a case brake configured to allow the water passing through the capacitive deionization filter to flow to the sump and prevent the water from flowing back toward the capacitive deionization filter after the water has entered the case brake from the capacitive deionization filter;
a tank configured to store the water after the water is passed through the capacitive deionization filter;
a first flow path connecting the capacitive deionization filter and the tank;
a second flow path connecting the capacitive deionization filter and the case brake;
a third flow path connecting the tank and the sump; and
a fourth flow path connecting the case brake and the sump.

2. The dishwasher of claim 1, wherein a portion of the water passing through the capacitive deionization filter flows into the sump through the first flow path, the tank, and the third flow path, and
wherein another portion of the water passing through the capacitive deionization filter flows into the sump through the second flow path, the case brake, and the fourth flow path.

3. The dishwasher of claim 1, further comprising a valve configured to:
open the first flow path and close the second flow path to allow the water passing through the capacitive deionization filter to be stored in the tank through the first flow path; and
close the first flow path and open the second flow path to allow the water passing through the capacitive deionization filter to flow to the sump through the second flow path, the case brake, and the fourth flow path.

4. The dishwasher of claim 3, further comprising: at least one processor configured to:
control the valve to open the first flow path to allow the water passing through the capacitive deionization filter to be stored in the tank before the water is sprayed through the sprayer; and
control the valve to open the second flow path to allow the water passing through the capacitive deionization filter to flow to the case brake in response to the water being sprayed by the sprayer.

5. The dishwasher of claim 4, wherein
the at least one processor is further configured to allow the water stored in the tank and the water passing through the case brake to flow to the sump through the third flow path and the fourth flow path, respectively, in response to the water being sprayed by the sprayer.

6. The dishwasher of claim 5, further comprising:
a pump configured to allow the water stored in the tank to flow into the sump through the third flow path,
wherein the at least one processor is further configured to drive the pump and open the valve so that the water stored in the tank and the water passing through the case brake flow to the sump through the third flow path and the fourth flow path, respectively, in response to the water being sprayed through the sprayer.

7. The dishwasher of claim 6, wherein the at least one processor is further configured to drive the pump to prevent the water remaining in the tank from flowing to the sump through the third flow path before the water is sprayed through the sprayer.

8. The dishwasher of claim 6, wherein the at least one processor is further configured to:
control the valve to open the first flow path based on a cycle in which the water is sprayed through the sprayer; and
control the valve to close the first flow path and open the second flow path based on a predetermined amount of the water being stored in the tank.

9. The dishwasher of claim 8, wherein the at least one processor is further configured to control the valve to allow an amount of the water corresponding to the predetermined amount of the water being stored in the tank to flow to the case brake through the second flow path.

10. The dishwasher of claim 8, wherein based on the water, which passes through the capacitive deionization filter, flowing to the sump through the fourth flow path as the valve opens the second flow path, the at least one processor is further configured to drive the pump to cause the water stored in the tank to flow to the sump through the third flow path.

11. The dishwasher of claim 6, wherein the at least one processor is further configured to:
control the valve to allow a portion of the water passing through the capacitive deionization filter to be first stored in the tank and to allow another portion of the water passing through the capacitive deionization filter to flow to the case brake after a predetermined amount of water is stored in the tank; and
drive the pump to cause the water stored in the tank and the water passing through the case brake to flow simultaneously to the sump.

12. The dishwasher of claim 1, wherein the capacitive deionization filter comprises a first capacitive deionization filter and a second capacitive deionization filter connected in series with the first capacitive deionization filter.

13. The dishwasher of claim 1, wherein the capacitive deionization filter comprises a first capacitive deionization filter and a second capacitive deionization filter connected in parallel with the first capacitive deionization filter.

14. The dishwasher of claim 1, further comprising a backflow prevention valve on a flow path connecting the water source and the capacitive deionization filter and configured to prevent the water passing through the capacitive deionization filter from flowing back to ward the water source after the water has passed through the capacitive deionization filter.

15. The dishwasher of claim 1, wherein the case brake comprises an air brake having a siphon shape and configured to prevent the water from flowing back toward the capacitive deionization filter after the water has entered the case brake from the capacitive deionization filter, and
wherein the air brake comprises an air brake hole configured to allow a flow path inside the case brake to be opened to an outside to allow the flow path, through which the water flows, inside the case brake to be connected to the outside.

16. The dishwasher of claim 15, wherein in a state in which the water exceeds a predetermined hydraulic pressure of flow rate and flows into the case brake, the air brake is con figured to allow the water to move to the tub through the air brake.

17. The dishwasher of claim 16, wherein the case brake comprises:
a case forming an internal path;
an inlet configured to allow the water, which has passed through the capacitive deionization filter, to flow into the case and to the air brake; and
an outlet configured to allow the water, which has passed through the internal path of the case brake and through the air brake, to be discharged from the case to the sump.

18. The dishwasher of claim 17, further comprising a controller configured to control the amount of the water collected in the sump or sprayed by the sprayer,
wherein the case comprises a flow meter configured to measure a flow rate of the water passing through the case from the capacitive deionization filter and transmit electrical signals or data corresponding to the measured flow rate of the water passing through the case to the controller, and
wherein the controller is further configured to control the amount of the water collected in the sump or sprayed by the sprayer based on the measured flow rate of the water passing through the case.

19. A dishwasher comprising:
a tub;
a sprayer disposed in the tub and configured to spray water;
a sump;
a filter configured to filter the water;
a case brake;
a tank;
a first flow path connecting the filter and the tank;
a second flow path connecting the filter and the case brake;
a third flow path connecting the tank and the sump; and
a fourth flow path connecting the case brake and the sump,
wherein a water source supplies the water to the filter,
wherein the water flows from the filter to at least one of the case brake or the tank,
wherein the water flows from at least one of the case brake or the tank to the sump, and
wherein the water flows from the sump to the sprayer.

20. A dishwasher comprising:
a tub;
a sprayer disposed in the tub and configured to spray water;
a sump configured to receive the water supplied to the sprayer before the water is supplied to the sprayer;
a capacitive deionization filter configured to filter the water supplied from a water source before the water is supplied to the sump;
a case brake downstream from the capacitive deionization filter and configured to allow the water passing through the capacitive deionization filter to flow to the sump and comprising an air brake configured to prevent the water from flowing back toward the capacitive deionization filter after the water has entered the case brake from the capacitive deionization filter;
a tank downstream from the capacitive deionization filter and configured to store the water after the water is passed through the capacitive deionization filter;
a first flow path connecting the capacitive deionization filter and the tank;
a second flow path connecting the capacitive deionization filter and the case brake;
a third flow path connecting the tank and the sump; and
a fourth flow path connecting the case brake and the sump,
wherein the case brake is configured to supply the water to the sump within a predetermined period of time or the case brake and the tank are configured to supply the water to the sump simultaneously within the predetermined period of time.
